(19) United States
(12) Patent Application Publication
(10) Pub. No.: US 2023/0102597 A1
(43) Pub. Date: Mar. 30, 2023

(54) THERMOPLASTIC POLYAMIDE MOLDING COMPOSITIONS THAT RESIST HEAT

(71) Applicant: BASF SE, Ludwigshafen am Rhein (DE)

(72) Inventors: Anna Maria Mueller-Cristadoro, Lemfoerde (DE); Michael Roth, Ludwigshafen (DE); Michaela Heussler, Ludwigshafen (DE); Sebastian Wagner, Ludwigshafen (DE)

(21) Appl. No.: 17/759,213

(22) PCT Filed: Jan. 26, 2021
(86) PCT No.: PCT/EP2021/051659

§ 371 Date: Jul. 21, 2022

(30) Foreign Application Priority Data
Jan. 27, 2020 (EP) 20153929.3

(51) Int. Cl. C08L 77/06

(52) U.S. Cl. CPC C08L 77/06

(57) ABSTRACT

Disclosed herein is a thermoplastic molding composition which includes
A) from 10 to 99.9% by weight of a thermoplastic polyamide,
B) from 0.1 to 20% by weight of at least one hyperbranched polyester having an acid number in the range of from 10 to 700 mg KOH/g and a hydroxyl number in the range of from 0 to 550 mg KOH/g,
C) from 0 to 50% by weight of fibrous or particulate fillers, and
D) from 0 to 45% by weight of further additives,
where the total of the percentages by weight of components A) to D) is 100% by weight.

The invention relates to thermoplastic polyamide molding compositions having improved heat-aging resistance.

The invention further relates to the use of the molding compositions of the invention for producing fibers, foils, and moldings of any type, and also to the resultant moldings.

Thermoplastic polymers are often used in the form of glass fiber-reinforced molding compositions as materials in the design of components which during their lifetime have exposure to elevated temperatures. Such polymers, like polycarbonates, polyesters, polyamides, styrene polymers, polyurethanes and polyolefins, have structural elements that are particularly prone to oxidative degradation reactions, which can be accelerated by heat, light or catalysts.

Although the thermooxidative degradation can be delayed by adding known heat stabilizers, it cannot be prevented in the long term, and becomes apparent by way of example in a reduced level of mechanical properties.

An overview of the different classes of heat stabilizers comprising H-donors, hydroperoxide decomposers, alkyl radical scavengers and metal deactivators can be found in the Plastics Additives Handbook, chapter 1, edited by Hans Zweifel (6th edition, Carl Hanser Verlag, Munich).

Polymer compounds based on polyamide, polyester or polyketone can be stabilized against heat by a combination of organic triaryl phosphite and sterically hindered phenolic antioxidant as disclosed in DE 197 12 788 A1.

Different heat aging resistance (HAR) additives which counteract or delay thermooxidative degradation are used in polyamide molding composition, for example a combination of Cu-containing stabilizers with iron oxides, organic HALS (hindered amine light stabilizers) compounds or sterically hindered phenols or polyhydroxy alcohols. More recent HAR additives for polyamides are highly branched melamine polymers for melamine-urea polymers, as disclosed in WO 2011/110508 A1, highly functional polyetherols having a hydroxyl number of from 3 to 1350 mg KOH/n_{polyetherol}, as disclosed in WO 2011/157615, or polyacrylamides for polyvinylamides, as disclosed in WO 2012/0062594 A1.

US 2010/0029819A describes a resin composition include a polyamide resin, a polyol having the number-average molecular weight of less than 2000, an auxiliary stabilizer such as a copper stabilizer and hindered phenol, and a polymer reinforcing filler. Such systems are known for bleed out and surface effects after part molding or during part life time.

EP 2 881 439 A1 discloses polyamide compositions containing a polyol and a copolymer of at least one olefin with a methacrylic acid ester or acrylic acid ester of an aliphatic alcohol. The polyol employed has 2 to 12 hydroxyl groups and has an average relative molecular weight in the range of from 64 to 2000 g/mol. The polyols are employed for improving the stability of the polyamides against thermooxidative degradation. Furthermore, they shall lead to an improved flow behavior.

US 2013/0217814 A1 discloses flame-retardant polyamide compositions, comprising polyamide, halogen-free flame retardant selected from phosphorous compounds, boehmite, a polyhydric alcohol having more than two hydroxyl groups and a number average molecular weight (Mₙ) of about 2000 or less, and at least one reinforcing agent.

The heat-aging resistance of the known molding compositions remains unsatisfactory, in particular over prolonged periods of exposure to heat.

It is highly desirable to improve the heat-aging resistance (HAR) of these polymers, since this can achieve longer lifetimes for components subject to thermal stress or can reduce the risk that these fail. As an alternative, improved HAR can also permit the use of the components at higher temperatures.

It was therefore an object of the present invention to provide thermoplastic polyamide molding compositions, which have improved HAR, and which, after heat-aging, have good mechanical properties.

The object is achieved according to the present invention by a thermoplastic molding composition, comprising
A) from 10 to 99.9% by weight of a thermoplastic polyamide,
B) from 0.1 to 20% by weight of at least one hyperbranched polyester having an acid number in the range of from 10 to 700 mg KOH/g and a hydroxyl number in the range of from 0 to 550 mg KOH/g,
C) from 0 to 50% by weight of fibrous or particulate fillers,
D) from 0 to 45% by weight of further additives,
where the total of the percentages by weight of components A) to D) is 100% by weight.

The object is furthermore achieved by the use of at least one hyperbranched polyester having an acid number in the range of from 10 to 700 mg KOH/g and a hydroxyl number in the range of from 0 to 550 mg KOH/g as heat stabilizer in thermoplastic polyamide molding compositions.

The object is furthermore achieved by a fiber, foil or molding, made of the thermoplastic molding composition as defined above.

According to the present invention, it has been found that the addition of hyperbranched polyesters to polyamide molding materials leads to an increased heat stability which is maintained even after heat aging.

In contrast to the typical heat stabilizers selected from the family of copper complexes, hyperbranched polyesters offer a non-toxic and very effective alternative to the copper complexes.

It was surprisingly found that the use of a hyperbranched polyester in polyamide molding composition shows the improved heat stability, since a transamidation reaction may be expected to have negative effects on the blend behavior. However, on the contrary, a positive effect of the hyperbranched polyesters on the heat stability has been observed.

In contrast to low-molecular weight polyols, hyperbranched polyesters do not show any unwanted migration to the surface after parts molding or during the parts lifespan.

Unless stated otherwise, the following amounts are based on the total of components A) to D) which is 100% by weight.

The molding compositions of the invention comprise, as component A), from 30 to 99.9% by weight, preferably from 35 to 95% by weight, and in particular from 40 to 90% by weight, of at least one thermoplastic polyamide.

The polyamides of the molding compositions of the invention generally have a viscosity number (VN) (or reduced viscosity) of from 90 to 350 ml/g, preferably from 90 to 240 ml/g, more preferably from 110 to 240 ml/g, determined in a 0.5% strength by weight solution in 96% strength by weight sulfuric acid at 25° C. to ISO 307.

Preference is given to semicrystalline or amorphous resins with a molecular weight (weight average) of at least 5000, described by way of example in the following US patents: U.S. Pat. Nos. 2,071,250, 2,071,251, 2,130,523, 2,130,948, 2,241,322, 2,312,966, 2,512,606, and 3,393,210.

Preferred are aliphatic and semi-aromatic polyamides.

Examples of these are polyamides that derive from lactams having from 7 to 13 ring members, e.g. polycaprolactam, polycaprylolactam, and polylaurolactam, and also polyamides obtained via reaction of dicarboxylic acids with diamines.

Dicarboxylic acids which may be used are alkanedicarboxylic acids having from 4 to 40, preferably from 6 to 12, in particular from 6 to 10, carbon atoms, and aromatic dicarboxylic acids. Merely as examples, those that may be mentioned here are adipic acid, azelaic acid, sebacic acid, dodecanedioic acid and terephthalic and/or isophthalic acid.

Particularly suitable diamines are alkanediamines having from 4 to 12, in particular from 6 to 8, carbon atoms, and also m-xylylenediamine (e.g. Ultramid® X17 from BASF SE, where the molar ratio of m-xylylenediamine (MXDA) to adipic acid is 1:1), di(4-aminophenyl)methane, di(4-aminocyclohexyl)methane, 2,2-di(4-aminophenyl)propane, 2,2-di(4-aminocyclohexyl)propane, and 1,5-diamino-2-methylpentane.

Preferred polyamides are polyhexamethyleneadipamide, polyhexamethylenesebacamide, and polycaprolactam, and also nylon-6/6,6 copolyamides, in particular having a proportion of from 5 to 95% by weight of caprolactam units (e.g. Ultramid® C31 from BASF SE).

Other suitable polyamides are obtainable from ω-aminoalkylnitriles, e.g. aminocapronitrile (PA 6) and adipodinitrile with hexamethylenediamine (PA 66) via what is known as direct polymerization in the presence of water, for example as described in DE-A 10313681, EP-A 1198491 and EP 922065.

Mention may also be made of polyamides obtainable, by way of example, via condensation of 1,4-diaminobutane with adipic acid at an elevated temperature (nylon-4,6). Preparation processes for polyamides of this structure are described by way of example in EP-A 38 094, EP-A 38 582, and EP-A 39 524.

Other suitable examples are polyamides obtainable via copolymerization of two or more of the abovementioned monomers, and mixtures of two or more polyamides in any desired mixing ratio. Particular preference is given to mixtures of nylon-6,6 with other polyamides, in particular nylon-6/6,6 copolyamides.

Other copolyamides which have proven particularly advantageous are semiaromatic copolyamides, such as PA 6T/6 and PA 6T/66, where the triamine content of these is less than 0.5% by weight, preferably less than 0.3% by weight (see EP-A 299 444). Other polyamides resistant to high temperatures are known from EP-A 19 94 075 (PA 6T/6I/MXD6).

The following list, which is not comprehensive, comprises the polyamides A) mentioned and other polyamides A) for the purposes of the invention, and the monomers comprised:

AB polymers:

PA 4 Pyrrolidone

PA 6 ε-Caprolactam

PA 7 Ethanolactam

PA 8 Caprylolactam

PA 9 9-Aminopelargonic acid

PA 11 11-Aminoundecanoic acid

PA 12 Laurolactam

AA/BB polymers:

PA 46 Tetramethylenediamine, adipic acid

PA 56 Pentamethylenediamine, adipic acid

PA 510 Pentamethylenediamine, sebacic acid

PA 512 Pentamethylenediamine, decanedicarboxylic acid

PA 66 Hexamethylenediamine, adipic acid

PA 69 Hexamethylenediamine, azelaic acid

PA 610 Hexamethylenediamine, sebacic acid

PA 612 Hexamethylenediamine, decanedicarboxylic acid

PA 613 Hexamethylenediamine, undecanedicarboxylic acid

PA 1212 1,12-Dodecanediamine, decanedicarboxylic acid

PA 1313 1,13-Diaminotridecane, undecanedicarboxylic acid

PA 6T Hexamethylenediamine, terephthalic acid

PA MXD6 m-Xylylenediamine, adipic acid

PA 9T Nonamethylenediamine, terephthalic acid

Aa/Bb Polymers:

PA 6I Hexamethylenediamine, isophthalic acid

PA 6-3-T Trimethylhexamethylenediamine, terephthalic acid

PA 6/6T (see PA 6 and PA 6T)

PA 6/66 (see PA 6 and PA 66)

PA 6/12 (see PA 6 and PA 12)

PA 66/6/610 (see PA 66, PA 6 and PA 610)

PA 6I/6T, PA 6T/6I (see PA 6I and PA 6T)

PA PACM 12 Diaminodicyclohexylmethane, laurolactam

PA 6I/6T/PACM as PA 6I/6T+diaminodicyclohexylmethane

PA 6/6.36 Caprolactam/hexamethylenediamine, C₃₆-dicarboxylic acid

PA 6T/66 (see PA 6T and PA 66)

PA 12/MACMI Laurolactam, dimethyldiaminodicyclohexylmethane, isophthalic acid

PA 12/MACMT Laurolactam, dimethyldiaminodicyclohexylmethane, terephthalic acid

PA PDA-T Phenylenediamine, terephthalic acid

Most preferred are PA 6, PA 66, PA 6/66, PA 66/6, PA 6/6.36, PA 6I/6T, PA 6T/6I, PA 9T and PA 6T/66.

The molding compositions of the invention comprise, as component B), from 0.1 to 20% by weight, preferably from 0.2 to 10% by weight, and in particular from 0.5 to 4% by weight of hyperbranched polyesters having an acid number in the range of from 10 to 700 mg KOH/g and a hydroxy number in the range of from 0 to 550 mg KOH/g.

Preferably, the acid number is in the range of from 20 to 550 mg KOH/g, more preferably from 40 to 470 mg KOH/g, for example 80 to 470 mg KOH/g.

The hydroxyl number is preferably 0 mg KOH/g or in the range of from 100 to 450 mg KOH/g, more preferably 150 to 400 mg KOH/g. The acid number is determined according to the German standard DIN 53402, the hydroxyl number according to DIN 53240 part 2, as effective in 2019.

The hyperbranched polyester preferably has a number average molecular weight Mₙ in the range of from 350 to 20000 g/mol, more preferably of from 500 to 10000 g/mol, more preferably of from 500 to 5000 g/mol

The weight average molecular weight M_{w} is preferably in the range of from 500 to 100000 g/mol, more preferably 800 to 50000 g/mol, most preferably 1000 to 10000 g/mol. The number average and weight average molecular weight are determined by gel permeation chromatography in dimethyl acetamide (calibration against PMMA, detection system: refractive index).

Hyperbranched polyesters are polyesters which are composed of at least 3-functional alcohols which are combined or reacted with dicarboxylic acids or at least 3-functional carboxylic acids which are combined or reacted with diols, leading to branched polyesters. The term “hyperbranched” defines that more than one branching is present and that typically multiple branching along the polymer chain occurs.

Typical hyperbranched polyesters are obtainable by reacting
a) one or more dicarboxylic acid(s) or one or more derivative(s) thereof with one or more at least three functional alcohols, or
b) one or more tricarboxylic acid(s) or higher polycarboxylic acids, or one or more derivative(s) thereof with one or more diol(s).

Hyperbranched polyesters containing unsaturated ethylene groups can be obtained by reacting
a) one or more dicarboxylic acid(s) or one or more derivative(s) thereof with one or more at least three functional alcohols, or
b) one or more tricarboxylic acid(s) or higher polycarboxylic acids, or one or more derivative(s) thereof with one or more diol(s);
   and then reacting the synthesis product with
c) at least one compound having at least one ethylenically unsaturated double bond.

Most preferred are hyperbranched polyesters obtainable by reacting dicarboxylic acids with 3- to 5-functional aliphatic alcohols, like trimethylolpropane and pentaerythritol.

For a further description of the hyperbranched polyesters employed according to the present invention, reference can be made to US 2005/0165177 A1 and US 2007/0027269 A1, respectively. The reaction takes typically place in the presence of a solvent, and optionally in the presence of an inorganic, organometallic or low molecular mass organic catalyst.

High-functionality hyperbranched polyesters for the purposes of the present invention are molecularly and structurally nonuniform. As a result of their molecular nonuniformity they differ from dendrimers and can therefore be prepared with considerably less effort.

Fora definition of the hyperbranched polymers, see also P. J. Flory, J. Am. Chem. Soc. 1952, 74, 11, 2718-2723 and A. Sunder et al., Chem. Eur. J., 2000, 6, Issue 1, 1-8. By “high-functionality hyperbranched” is meant in connection with the present invention that branching is present in from 30 to 70 mol %, preferably from 40 to 60 mol % of each monomer unit.

The dicarboxylic acids which can be reacted in accordance with version (a) include, for example, oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid and also cis- and trans-cyclopentane-1,3-dicarboxylic acid, it being possible for the abovementioned dicarboxylic acids to be substituted by one or more radical(s) selected from C₁-C₁₀-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl or n-decyl, C₃-C₁₂-cycloalkyl groups, such as cyclopropyl, cyclobutyl, cyclopentyl, cyclohexyl, cycloheptyl, cyclooctyl, cyclononyl, cyclodecyl, cycloundecyl and cyclododecyl; preference is given to cyclopentyl, cyclohexyl and cycloheptyl; alkylene groups such as methylene or ethylidene or C₆-C₁₄-aryl groups such as phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, more preferably phenyl.

As exemplary representatives of substituted dicarboxylic acids mention may be made of the following: 2-methylmalonic acid, 2-ethylmalonic acid, 2-phenylmalonic acid, 2-methylsuccinic acid, 2-ethylsuccinic acid, 2-phenylsuccinic acid, itaconic acid, 3,3-dimethylglutaric acid.

The dicarboxylic acids which can be reacted in accordance with version (a) further include ethylenically unsaturated acids such as maleic acid and fumaric acid, for example, and also aromatic dicarboxylic acids such as phthalic acid, isophthalic acid or terephthalic acid, for example.

Mixtures of two or more of the afore mentioned representatives can also be used.

The dicarboxylic acids can be used either as they are or in the form of derivatives, e.g. in the form of anhydrides.

By derivatives are meant preferably the corresponding anhydrides in monomeric or else polymeric form, mono- or dialkyl esters, preferably mono- or dimethyl esters or the corresponding mono- or diethyl esters, but also the mono- and dialkyl esters derived from higher alcohols such as n-propanol, isopropanol, n-butanol, isobutanol, tert-butanol, n-pentanol and n-hexanol, for example, additionally mono- and divinyl esters, and also mixed esters, preferably methyl ethyl esters.

In the context of the present invention it is also possible to use a mixture of dicarboxylic acid and one or more of its derivatives. Likewise, it is possible in the context of the present invention to use a mixture of two or more different derivatives of one or more dicarboxylic acids.

Particular preference is given to using succinic acid, glutaric acid, adipic acid, phthalic acid, hexahydrophthalic acid, isophthalic acid, hexahydroisophthalic acid, terephthalic acid, hexahydroterephthalic acid or their mono- or dimethyl esters. Very particular preference is given to using adipic acid.

At least trifunctional alcohols which can be reacted include for example the following: glycerol, butane-1,2,4- triol, n-pentane-1,2,5-triol, n-pentane-1,3,5-triol, n-hexane-1,2,6-triol, n-hexane-1,2,5-triol, n-hexane-1,3,6-triol, trimethylolbutane, trimethylolpropane or di-trimethylolpropane, trimethylolethane, pentaerythritol or dipentaerythritol; sugar alcohols such as mesoerythritol, threitol, sorbitol, mannitol, for example, or mixtures of the above at least trifunctional alcohols. Preference is given to using glycerol, trimethylolpropane, trimethylolethane and pentaerythritol.

Tricarboxylic acids or polycarboxylic acids which can be reacted in accordance with version (b) are, for example, 1,2,4-benzenetricarboxylic acid, 1,3,5-benzenetricarboxylic acid, 1,2,4,5-benzenetetracarboxylic acid and also mellitic acid.

In the reaction according to the invention tricarboxylic acids or polycarboxylic acids can be used either as they are or else in the form of derivatives.

By derivatives are meant preferably the corresponding anhydrides in monomeric or else polymeric form, mono-, di- or trialkyl esters, preferably mono-, di- or trimethyl esters or the corresponding mono-, di- or triethyl esters, but also the mono-, di- and triesters derived from higher alcohols such as n-propanol, isopropanol, n-butanol, isobutanol, tert-butanol, n-pentanol and n-hexanol, for example, and also mono-, di- or trivinyl esters, and also mixed methyl ethyl esters.

In the context of the present invention it is also possible to use a mixture of a tricarboxylic or polycarboxylic acid and one or more of its derivatives. Likewise, it is possible in the context of the present invention to use a mixture of two or more different derivatives of one or more tricarboxylic or polycarboxylic acids.

As diols for version (b) of the present invention use is made for example of ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol 1,7-heptanediol, 1,8-octanediol, 1,2-octanediol, 1,9-nonanediol, 1,10-decanediol, 1,2-decanediol, 1,12-dodecanediol, 1,2-dodecanediol, 1,5-hexadiene-3,4-diol, cyclopentanediols, cyclohexanediols, inositol and derivatives, (2)-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, tripropylene glycol, polyethylene glycols HO(CH₂CH₂O), —H or polypropylene glycols HO(CH[CH₃]CH₂O), —H or mixtures of two or more representatives of the above compounds, n being an integer and n=4. One or else both of the hydroxyl groups in the aforementioned diols can also be substituted by SH groups. Preference is given to ethylene glycol, propane-1,2-diol and also diethylene glycol, triethylene glycol, dipropylene glycol and tripropylene glycol.

The molar ratio of hydroxyl groups to carboxyl groups in the case of versions (a) and (b) are preferably from 2:1 to 1:2, in particular from 1.5:1 to 1:1.5.

The at least trifunctional alcohols which are reacted in accordance with version (a) of the process of the invention may have hydroxyl groups each of equal reactivity. Preference is also given here to at least trifunctional alcohols whose OH groups are initially of equal reactivity but in which by reaction with at least one acid group it is possible to induce a drop-in reactivity, caused by steric or electronic influences, among the remaining OH groups. This is the case, for example, when trimethylolpropane or pentaerythritol is used.

The at least trifunctional alcohols which are reacted in accordance with version (a) of the process of the invention may also, however, contain hydroxyl groups having at least two chemically different reactivities.

The different reactivity of the functional groups may derive either from chemical causes (e.g., primary/secondary/tertiary OH group) or from steric causes.

By way of example the triol may be a triol which contains primary and secondary hydroxyl groups: a preferred example is glycerol.

When carrying out the inventive reaction in accordance with version (a), it is preferred to operate in the absence of diols and monofunctional alcohols. Preferably, only dicarboxylic acids are employed as acid component.

When carrying out the inventive reaction in accordance with version (b), it is preferred to operate in the absence of monocarboxylic or dicarboxylic acids. Preferably, only diols are employed as alcohol component.

For suitable solvents and catalysts, reference can be made to US 2005/0165177 A1.

The hyperbranched polyesters employed according to the present invention are carboxy-terminated or carboxy- and hydroxyl-terminated. The acid number and hydroxyl number of the hyperbranched polyester are adjusted by employing suitable molar amounts or ratios of carboxylic acids and alcohols, e.g. of polyols and diacids or of polycarboxylic acids and diols.

According to one embodiment of the present invention, the hyperbranched polyester contains ethylenically unsaturated groups. These compounds having at least one ethylenic double bond are preferably compounds having a terminal ethylenic double bond, i.e. one of the two carbon atoms of the C—C double bond carrying only hydrogen atoms as substituents. Compounds containing ethylenically unsaturated double bonds can be, for example, ethylenically unsaturated carboxylic acids, unsaturated alcohols, unsaturated amines or unsaturated carboxylic esters. Typical compounds are disclosed in US 2007/0027269 A1 in paragraphs [0058] to [0094]. The hyperbranched polyesters containing ethylenically unsaturated groups can be prepared as disclosed in US 2007/0027269 A1 in paragraphs [0102] to [0157]. A specifically preferred compound having at least one ethylenic double bond are compounds of the formula (Ia) and (Ib), as disclosed in US 2007/0027269 A1 in paragraph [0058]. Most preferably, maleic anhydride is employed.

The molding compositions of the invention can comprise as component C) from 0 to 50% by weight, preferably from 0 to 45% by weight, more preferably from 0 to 40% by weight of fibrous or particulate fillers. If these fillers are employed in the molding compositions according to the present invention, their amount is preferably 1 to 50% by weight, more preferably 5 to 45% by weight, most preferably 10 to 40% by weight, for example 30% by weight. In this case, the maximum amount of the polyamide component A) is reduced by the amount of fillers. Therefore, in case that the filler is employed in the above preferred ranges, the amount of thermoplastic polyamide is 30 to 98.9% by weight, preferably 35 to 90% by weight, more preferably 40 to 85% by weight.

Preference is given to polyamide molding compositions containing the fibrous or particulate fillers.

Fibrous or particulate fillers C) that may be mentioned are carbon fibers, glass fibers, glass beads, amorphous silica, calcium silicate, calcium metasilicate, magnesium carbonate, kaolin, chalk, powdered quartz, mica, barium sulfate, carbonate, alkaline earth metal oxide, alkaline earth metal silicate, metallic fibre, ceramic fibre, aramid fibre, titanium dioxide, aluminum oxide, talc, plaster, zirconium oxide, antimony oxide, clay, silica-alumina, sericite, kaolin, diatomite, feldspar, silica stone, carbon black, Shirasu® balloon, red oxide, zinc oxide, wollastonite and Syloid®.

Preferred fibrous fillers that may be mentioned are carbon fibers, aramid fibers, and potassium titanate fibers, particular preference being given to glass fibers in the form of E glass. These can be used as rovings or in the commercially available forms of chopped glass.

The fibrous fillers may have been surface-pretreated with a silane compound to improve compatibility with the thermoplastic.

Suitable silane compounds have the general formula:

(X—(CH₂)ₙ)ₖ—Si—(O—CₘH₂ₘ₊₁)₄₋ₖ

where the definitions of the substituents are as follows:

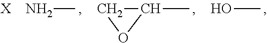

n is a whole number from 2 to 10, preferably 3 to 4,

m is a whole number from 1 to 5, preferably 1 to 2, and

k is a whole number from 1 to 3, preferably 1.

Preferred silane compounds are aminopropyltrimethoxysilane, aminobutyltrimethoxysilane, aminopropyltriethoxysilane and aminobutyltriethoxysilane, and also the corresponding silanes which comprise a glycidyl group as substituent X.

The amounts of the silane compounds generally used for surface-coating are from 0.01 to 2% by weight, preferably from 0.025 to 1.0% by weight and in particular from 0.05 to 0.5% by weight (based on C).

Acicular mineral fillers are also suitable.

For the purposes of the invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may optionally have been pretreated with the abovementioned silane compounds, but the pretreatment is not essential.

Other fillers which may be mentioned are kaolin, calcined kaolin, wollastonite, talc and chalk, and also lamellar or acicular nanofillers, the amounts of these preferably being from 0.1 to 10%. Materials preferred for this purpose are boehmite, bentonite, montmorillonite, vermiculite, hectorite, and laponite. The lamellar nanofillers are organically modified by prior-art methods, to give them good compatibility with the organic binder. Addition of the lamellar or acicular nanofillers to the inventive nanocomposites gives a further increase in mechanical strength.

The molding compositions of the invention can comprise, as component D), up to 45% by weight, preferably up to 40% by weight, more preferably up to 30% by weight, of further additives.

The thermoplastic molding compositions of the invention can comprise, as component D), conventional processing aids, such as stabilizers, oxidation retarders, agents to counteract decomposition by heat and decomposition by ultraviolet light, lubricants and mold-release agents, colorants, such as dyes and pigments, nucleating agents, plasticizers, flame retardants, etc.

The molding compositions of the invention can comprise, as component D1), from 0.05 to 3% by weight, preferably from 0.1 to 1.5% by weight, and in particular from 0.1 to 1% by weight, of a lubricant.

Preference is given to the salts of Al, of alkali metals, or of alkaline earth metals, or esters or amides of fatty acids having from 10 to 44 carbon atoms, preferably having from 12 to 44 carbon atoms.

The metal ions are preferably alkaline earth metal and Al, particular preference being given to Ca or Mg.

Preferred metal salts are Ca stearate and Ca montanate, and also Al stearate.

It is also possible to use a mixture of various salts, in any desired mixing ratio.

The carboxylic acids can be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic amines can be mono- to tribasic. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or amides, or of esters with amides in combination, in any desired mixing ratio.

The molding compositions of the invention can comprise, as component D2), from 0.05 to 3% by weight, preferably from 0.1 to 1.5% by weight, and in particular from 0.1 to 1% by weight, of a copper stabilizer, preferably of a Cu(I) halide, in particular in a mixture with an alkali metal halide, preferably KI, in particular in the ratio 1:4, or of a sterically hindered phenol, or a mixture of these.

Preferred salts of monovalent copper used are cuprous acetate, cuprous chloride, cuprous bromide, and cuprous iodide. The materials comprise these in amounts of from 5 to 500 ppm of copper, preferably from 10 to 250 ppm, based on polyamide.

The advantageous properties are in particular obtained if the copper is present with molecular distribution in the polyamide. This is achieved if a concentrate comprising the polyamide, and comprising a salt of monovalent copper, and comprising an alkali metal halide in the form of a solid, homogeneous solution is added to the molding composition. By way of example, a typical concentrate is composed of from 79 to 95% by weight of polyamide and from 21 to 5% by weight of a mixture composed of copper iodide or copper bromide and potassium iodide. The copper concentration in the solid homogeneous solution is preferably from 0.3 to 3% by weight, in particular from 0.5 to 2% by weight, based on the total weight of the solution, and the molar ratio of cuprous iodide to potassium iodide is from 1 to 11.5, preferably from 1 to 5.

According to the present invention it is preferred to employ molding compositions free of metal halides, since metal halides can lead to corrosion and migration problems

According to one embodiment of the present invention, the molding compositions are free from metal halides and especially free from copper iodide and potassium iodide.

Suitable polyamides for the concentrate are homopolyamides and copolyamides, in particular nylon-6 and nylon-6,6.

Examples of oxidation retarders and heat stabilizers are sterically hindered phenols and/or phosphites and amines (e.g. TAD), hydroquinones, aromatic secondary amines, such as diphenylamines, various substituted members of these groups, and mixtures of these, in concentrations of up to 1% by weight, based on the weight of the thermoplastic molding compositions.

Suitable sterically hindered phenols D4) are in principle all of the compounds which have a phenolic structure, and which have at least one bulky group on the phenolic ring.

It is preferable to use, for example, compounds of the formula

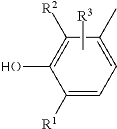

where:

R¹ and R² are an alkyl group, a substituted alkyl group, or a substituted triazole group, and where the radicals R¹ and R² may be identical or different, and R³ is an alkyl group, a substituted alkyl group, an alkoxy group, or a substituted amino group.

Antioxidants of the abovementioned type are described by way of example in DE-A 27 02 661 (U.S. Pat. No. 4,360,617).

Another group of preferred sterically hindered phenols is provided by those derived from substituted benzenecarboxylic acids, in particular from substituted benzenepropionic acids.

Particularly preferred compounds from this class are compounds of the formula

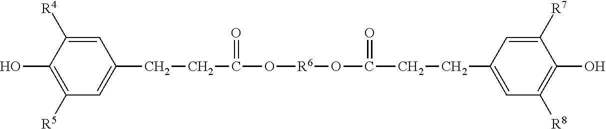

where R⁴, R⁵, R⁷, and R⁸, independently of one another, are C₁-C₈-alkyl groups which themselves may have substitution (at least one of these being a bulky group), and R⁶ is a divalent aliphatic radical which has from 1 to 10 carbon atoms and whose main chain may also have CO bonds.

Preferred compounds corresponding to these formulae are

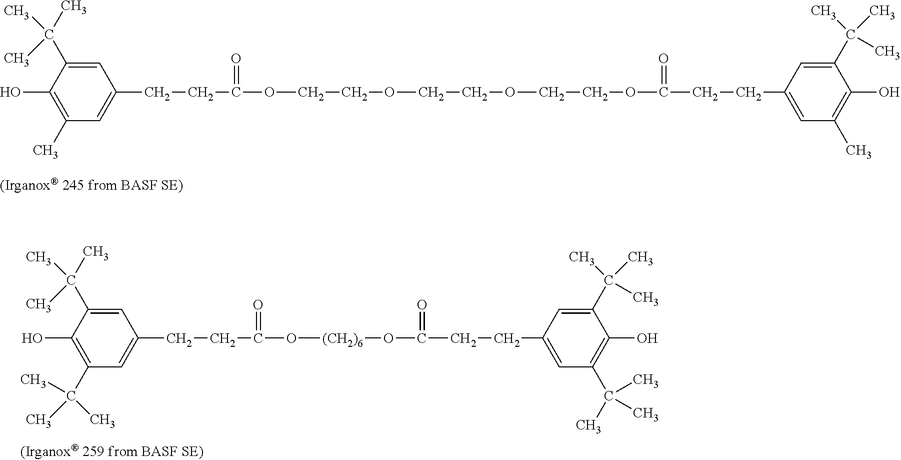

All of the following should be mentioned as examples of sterically hindered phenols:

2,2′-methylenebis(4-methyl-6-tert-butylphenol), 1,6-hexanediol bis[3-(3,5-di-tert-butyl-4-hydroxyphenyl)propionate], pentaerythrityl tetrakis[3-(3,5-di-tert-butyl-4-hydroxyphenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine.

Compounds which have proven particularly effective and which are therefore used with preference are 2,2′-methylenebis(4-methyl-6-tert-butylphenol), 1,6-hexanediol bis(3,5-di-tert-butyl-4-hydroxyphenyl)propionate (Irganox® 259), pentaerythrityl tetrakis[3-(3,5-di-tert-butyl-4-hydroxyphenyl)propionate], and also N,N′-hexamethylenebis-3,5-di-tert-butyl-4-hydroxyhydrocinnamide (Irganox® 1098), and the product Irganox® 245 described above from BASF SE, which has particularly good suitability.

The amount comprised of the antioxidants D), which can be used individually or as a mixture, is from 0.05 up to 3% by weight, preferably from 0.1 to 1.5% by weight, in particular from 0.1 to 1% by weight, based on the total weight of the molding compositions A) to D).

In some instances, sterically hindered phenols having not more than one sterically hindered group in ortho-position with respect to the phenolic hydroxy group have proven particularly advantageous; in particular when assessing colorfastness on storage in diffuse light over prolonged periods.

The molding compositions of the invention can comprise, as component D4), from 0.05 to 5% by weight, preferably from 0.1 to 2% by weight, and in particular from 0.25 to 1.5% by weight, of a nigrosine.

Nigrosines are generally a group of black or gray phenazine dyes (azine dyes) related to the indulines and taking various forms (water-soluble, oil-soluble, spirit-soluble), used in wool dyeing and wool printing, in black dyeing of silks, and in the coloring of leather, of shoe creams, of varnishes, of plastics, of stoving lacquers, of inks, and the like, and also as microscopy dyes.

Nigrosines are obtained industrially via heating of nitrobenzene, aniline, and aniline hydrochloride with metallic iron and FeCl₃ (the name being derived from the Latin niger=black).

Component D4) can be used in the form of free base or else in the form of salt (e.g. hydrochloride).

Further details concerning nigrosines can be found by way of example in the electronic encyclopedia Römpp Online, Version 2.8, Thieme-Verlag Stuttgart, 2006, keyword “Nigrosine”.

The molding compositions of the invention can comprise, as component D5), from 0.001 to 20% by weight, preferably from 0.05 to 10% by weight, and in particular from 0.1 to 5% by weight, of iron powder with a particle size of at most 10 μm (d₅₀ value), where the powder is preferably obtainable via thermal decomposition of pentacarbonyl iron.

Iron occurs in a number of allotropes:
1. α-Fe (ferrite) forms space-centered cubic lattices, is magnetizable, dissolves a small amount of carbon, and occurs in pure iron up to 928° C. At 770° C. (Curie temperature) it loses its ferromagnetic properties and becomes paramagnetic; iron in the temperature range from 770 to 928° C. is also termed β-Fe. At normal temperature and at a pressure of at least 13 000 M Pa, α-Fe becomes what is known as s-Fe with a reduction of about 0.20 cm³/mol in volume, whereupon density increases from 7.85 to 9.1 (at 20 000 M Pa);
2. γ-Fe (austenite) forms face-centered cubic lattices, is nonmagnetic, dissolves a large amount of carbon, and is observable only in the temperature range from 928 to 1398° C.;
3. δ-Fe, space-centered, exists at from 1398° C. to the melting point of 1539° C.

Metallic iron is generally silver-white, density 7.874 (heavy metal), melting point 1539° C., boiling point 2880° C.; specific heat (from 18 to 100° C.) about 0.5 g⁻¹ K⁻¹, tensile strength from 220 to 280 N/mm². The values apply to chemically pure iron.

Industrial production of iron uses smelting of iron ores, iron slags, calcined pyrites, or blast-furnace dust, and resmelting of scrap and alloys.

The iron powder of the invention is produced via thermal decomposition of pentacarbonyl iron, preferably at temperatures of from 150° C. to 350° C. The particles thus obtainable have a preferably spherical shape, therefore being spherical or almost spherical (another term used to be spherulitic).

Preferred iron powder has the particle size distribution described below; particle size distribution here is determined by means of laser scattering in very dilute aqueous suspension (e.g. using a Beckmann LS13320). The particle size (and distribution) described hereinafter can optionally be obtained via grinding and/or sieving.
dₓₓ here means that XX % of the total volume of the particles is smaller than the stated value.
d₅₀ values: at most 10 μm, preferably from 1.6 to 8 μm, in particular from 2.9 to 7.5 μm, very particularly from 3.4 to 5.2 μm
d₁₀ values: preferably from 1 to 5 μm, in particular from 1 to 3 μm, and very particularly from 1.4 to 2.7 μm
d₉₀ values: preferably from 3 to 35 μm, in particular from 3 to 12 μm, and very particularly from 6.4 to 9.2 μm.

Component C6) preferably has iron content of from 97 to 99.8 g/100 g, preferably from 97.5 to 99.6 g/100 g. Content of other metals is preferably below 1000 ppm, in particular below 100 ppm, and very particularly below 10 ppm.

Fe content is usually determined via infrared spectroscopy.

C content is preferably from 0.01 to 1.2 g/100 g, preferably from 0.05 to 1.1 g/100 g, and in particular from 0.4 to 1.1 g/100 g. This C content in the preferred iron powders corresponds to that of powders which are not reduced using hydrogen after the thermal decomposition process.

The carbon content is usually determined by combustion of the sample in a stream of oxygen and then using IR to detect the resultant CO₂ gas (by means of a Leco CS230 or CS-mat 6250 from Juwe) by a method based on ASTM E1019.

Nitrogen content is preferably at most 1.5 g/100 g, preferably from 0.01 to 1.2 g/100 g. Oxygen content is preferably at most 1.3 g/100 g, preferably from 0.3 to 0.65 g/100 g. N and O are determined via heating of the specimen to about 2100° C. in a graphite furnace. The oxygen obtained from the specimen here is converted to CO and measured by way of an IR detector. The N liberated under the reaction conditions from the N-containing compounds is discharged with the carrier gas and detected and recorded by means of TCD (Thermal Conductivity Detector) (both methods based on ASTM E1019).

Tap density is preferably from 2.5 to 5 g/cm³, in particular from 2.7 to 4.4 g/cm³. This generally means the density when the powder is, for example, charged to the container and compacted by vibration. Iron powders to which further preference is given can have been surface-coated with iron phosphate, with iron phosphite, or with SiO₂.

BET surface area to DIN ISO 9277 is preferably from 0.1 to 10 m²/g, in particular from 0.1 to 5 m²/g, and preferably from 0.2 to 1 m²/g, and in particular from 0.4 to 1 m²/g.

In order to achieve particularly good dispersion of the iron particles, a masterbatch may be used, involving a polymer. Suitable polymers for this purpose are polyolefins, polyesters, or polyamides, and it is preferable here that the masterbatch polymer is the same as component A). The mass fraction of the iron in the polymer is generally from 15 to 80% by mass, preferably from 20 to 40% by mass.

Examples of other conventional additives D6) are amounts of up to 25% by weight, preferably up to 20% by weight, of elastomeric polymers (also often termed impact modifiers, elastomers, or rubbers).

These are very generally copolymers preferably composed of at least two of the following monomers: ethylene, propylene, butadiene, isobutene, isoprene, chloroprene, vinyl acetate, styrene, acrylonitrile and acrylates and/or methacrylates having from 1 to 18 carbon atoms in the alcohol component.

Polymers of this type are described, for example, in Houben-Weyl, Methoden der organischen Chemie, vol. 14/1 (Georg-Thieme-Verlag, Stuttgart, Germany, 1961), pages 392 to 406, and in the monograph by C. B. Bucknall, “Toughened Plastics” (Applied Science Publishers, London, U K, 1977).

Some preferred types of such elastomers are described below.

Preferred types of such elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricycledienes, such as 3-methyltricyclo[5.2.1.0^{2,6}]-3,8-decadiene, and mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM rubbers and EPDM rubbers may preferably also have been grafted with reactive carboxylic acids or with derivatives of these. Examples of these are acrylic acid, methacrylic acid and derivatives thereof, e.g. glycidyl (meth)acrylate, and also maleic anhydride.

Copolymers of ethylene with acrylic acid and/or methacrylic acid and/or with the esters of these acids are another group of preferred rubbers. The rubbers may also comprise dicarboxylic acids, such as maleic acid and fumaric acid, or derivatives of these acids, e.g. esters and anhydrides, and/or monomers comprising epoxy groups. These dicarboxylic acid derivatives or monomers comprising epoxy groups are preferably incorporated into the rubber by adding to the monomer mixture monomers comprising dicarboxylic acid groups and/or epoxy groups and having the general formulae I or II or III or IV

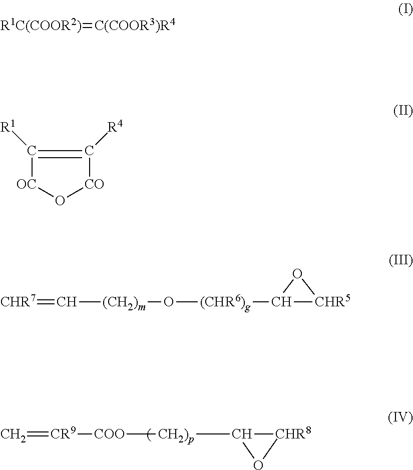

where R¹ to R⁹ are hydrogen or alkyl groups having from 1 to 6 carbon atoms, and m is a whole number from 0 to 20, g is a whole number from 0 to 10 and p is a whole number from 0 to 5.

The radicals R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and (meth)acrylates comprising epoxy groups, such as glycidyl acrylate and glycidyl methacrylate, and the esters with tertiary alcohols, such as tert-butyl acrylate. Although the latter have no free carboxy groups, their behavior approximates to that of the free acids and they are therefore termed monomers with latent carboxy groups.

The copolymers are advantageously composed of from 50 to 98% by weight of ethylene, from 0.1 to 20% by weight of monomers comprising epoxy groups and/or methacrylic acid and/or monomers comprising anhydride groups, the remaining amount being (meth)acrylates.

Particular preference is given to copolymers composed of
from 50 to 98% by weight, in particular from 55 to 95% by weight, of ethylene,
from 0.1 to 40% by weight, in particular from 0.3 to 20% by weight, of glycidyl acrylate and/or glycidyl methacrylate, (meth)acrylic acid and/or maleic anhydride, and
from 1 to 45% by weight, in particular from 5 to 40% by weight, of n-butyl acrylate and/or 2-ethylhexyl acrylate.

Other preferred (meth)acrylates are the methyl, ethyl, propyl, isobutyl and tert-butyl esters.

Comonomers which may be used alongside these are vinyl esters and vinyl ethers.

The ethylene copolymers described above may be prepared by processes known per se, preferably by random copolymerization at high pressure and elevated temperature. Appropriate processes are well-known.

Other preferred elastomers are emulsion polymers whose preparation is described, for example, by Blackley in the monograph “Emulsion Polymerization”. The emulsifiers and catalysts which can be used are known per se.

In principle it is possible to use homogeneously structured elastomers or else those with a shell structure. The shell-type structure is determined by the sequence of addition of the individual monomers. The morphology of the polymers is also affected by this sequence of addition.

Monomers which may be mentioned here, merely as examples, for the preparation of the rubber fraction of the elastomers are acrylates, such as, for example, n-butyl acrylate and 2-ethylhexyl acrylate, corresponding methacrylates, butadiene and isoprene, and also mixtures of these. These monomers may be copolymerized with other monomers, such as, for example, styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). Elastomers having more than one shell may also have more than one shell composed of a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, α-methylstyrene, p-methylstyrene, or acrylates or methacrylates, such as methyl acrylate, ethyl acrylate or methyl methacrylate. Besides these, it is also possible to use relatively small proportions of other comonomers.

It is advantageous in some cases to use emulsion polymers which have reactive groups at their surfaces. Examples of groups of this type are epoxy, carboxy, latent carboxy, amino and amide groups, and also functional groups which may be introduced by concomitant use of monomers of the general formula

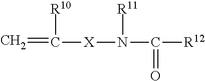

where the substituents can be defined as follows:
R¹⁰ is hydrogen or a C₁-C₄-alkyl group,
R¹¹ is hydrogen, a C₁-C₈-alkyl group or an aryl group, in particular phenyl,
R₁₂ is hydrogen, a C₁-C₁₀-alkyl group, a C₆-C₁₂-aryl group, or —OR¹³,
R¹³ is a C₁-C₈-alkyl group or a C₆-C₁₂-aryl group, which can optionally have substitution by groups that comprise O or by groups that comprise N,
X is a chemical bond, a C₁-C₁₀-alkylene group, or a C₆-C₁₂-arylene group, or

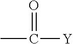

Y is O—Z or NH—Z, and
Z is a C₁-C₁₀-alkylene or C₆-C₁₂-arylene group.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of compounds of this type in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers comprising allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in the impact-modifying polymer is generally up to 5% by weight, preferably not more than 3% by weight, based on the impact-modifying polymer.

Some preferred emulsion polymers are listed below. Mention may first be made here of graft polymers with a core and with at least one outer shell, and having the following structure:

| Type | Monomers for the core | Monomers for the envelope |
|---|---|---|
| I | 1,3-butadiene, isoprene, n-butyl | styrene, acrylonitrile, methyl methacrylate |
| | acrylate, ethylhexyl acrylate, or | |
| | a mixture of these | |
| II | as I, but with concomitant use | as I |
| | of crosslinking agents | |
| III | as I or II | n-butyl acrylate, ethyl acrylate, methyl acrylate, |
| | | 1,3-butadiene, isoprene, ethylhexyl acrylate |
| IV | as I or II | as I or III, but with concomitant use of monomers |
| | | having reactive groups, as described herein first |
| V | styrene, acrylonitrile, methyl | envelope composed of monomers as described |
| | meth-acrylate, or a mixture | under I and II for the core, second envelope |
| | of these | as described under I or IV for the envelope |

Instead of graft polymers whose structure has more than one shell, it is also possible to use homogeneous, i.e. single-shell, elastomers composed of 1,3-butadiene, isoprene and n-butyl acrylate or of copolymers of these. These products, too, may be prepared by concomitant use of crosslinking monomers or of monomers having reactive groups.

Examples of preferred emulsion polymers are n-butyl acrylate-(meth)acrylic acid copolymers, n-butyl acrylate/glycidyl acrylate or n-butyl acrylate/glycidyl methacrylate copolymers, graft polymers with an inner core composed of n-butyl acrylate or based on butadiene and with an outer envelope composed of the abovementioned copolymers, and copolymers of ethylene with comonomers which supply reactive groups.

The elastomers described may also be prepared by other conventional processes, e.g. by suspension polymerization.

Preference is also given to silicone rubbers, as described in DE-A 37 25 576, EP-A 235 690, DE-A 38 00 603 and EP-A 319 290.

It is, of course, also possible to use mixtures of the types of rubber listed above.

UV stabilizers that may be mentioned, the amounts of which used are generally up to 2% by weight, based on the molding composition, are various substituted resorcinols, salicylates, benzotriazoles, and benzophenones.

Materials that can be added as colorants are inorganic pigments, such as titanium dioxide, ultramarine blue, iron oxide, and carbon black, and also organic pigments, such as phthalocyanines, quinacridones, perylenes, and also dyes, such as anthraquinones.

Materials that can be used as nucleating agents are sodium phenylphosphinate, aluminum oxide, silicon dioxide, and also preferably talc.

Flame Retardants

As component D the thermoplastic molding materials can comprise 1.0 to 10.0 wt %, preferably 2.0 to 6.0, in particular 3.0 to 5.0 wt %, of at least one phosphazene of general formula (IX) or (X) as flame retardant.

“Phosphazenes” is to be understood as meaning cyclic phosphazenes of general formula (IX)

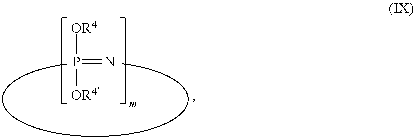

in which m is an integer from 3 to 25 and R⁴ and R^{4′} are identical or different and represent C₁-C₂₀-alkyl-, C₆-C₃₀-aryl-, C₆-C₃₀-arylalkyl- or C₆-C₃₀-alkyl-substituted aryl or linear phosphazenes of general formula (X)

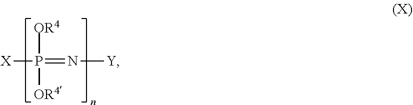

in which n represents 3 to 1000 and X represents —N═P(OPh)₃ or —N═P(O)OPh and Y represents —P(OPh)₄ or —P(O)(OPh)₂.

The production of such phosphazenes is described in EP-A 0 945 478.

Particular preference is given to cyclic phenoxyphosphazenes of formula P₃N₃C₃₆ of formula (XI)

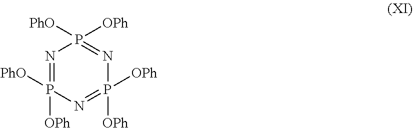 [SMILES: c1ccc(OP2(Oc3ccccc3)=NP(Oc3ccccc3)(Oc3ccccc3)=NP(Oc3ccccc3)(Oc3ccccc3)=N2)cc1]

or linear phenoxyphosphazenes according to formula (XII)

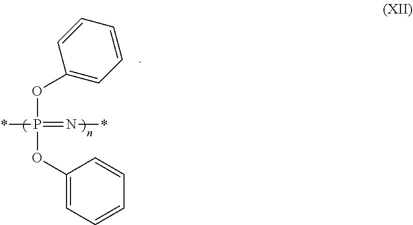

The phenyl radicals may optionally be substituted. Phosphazenes in the context of the present application are described in Mark, J. E., Allcock, H. R., West, R., “Inorganic Polymers”, Prentice Hall, 1992, pages 61 to 141.

Preferably employed as component D are cyclic phenoxyphosphazenes having at least three phenoxyphosphazene units. Corresponding phenoxyphosphazenes are described for example in US 2010/0261818 in paragraphs [0051] to [0053]. Reference may in particular be made to formula (I) therein. Corresponding cyclic phenoxyphosphazenes are furthermore described in EP-A-2 100 919, in particular in paragraphs [0034] to [0038] therein. Production may be effected as described in EP-A-2 100 919 in paragraph [0041]. In one embodiment of the invention the phenyl groups in the cyclic phenoxyphosphazene may be substituted by C₁₋₄-alkyl radicals. It is preferable when pure phenyl radicals are concerned.

For further description of the cyclic phosphazenes reference may be made to Römpp Chemie Lexikon, 9th ed., keyword “phosphazenes”. Production is effected for example via cyclophosphazene which is obtainable from PCl₅ and NH₄Cl, wherein the chlorine groups in the cyclophosphazene have been replaced by phenoxy groups by reaction with phenol.

The cyclic phenoxy phosphazene compound may for example be produced as described in Allcock, H. R., “Phosphorus-Nitrogen Compounds” (Academic Press, 1972), and in Mark, J. E., Allcock, H. R., West, R., “Inorganic Polymers” (Prentice Hall, 1992).

Component D is preferably a mixture of cyclic phenoxyphosphazenes having three and four phenoxy phosphazene units. The weight ratio of rings comprising three phenoxyphosphazene units to rings comprising four phenoxyphosphazene units is preferably about 80:20. Larger rings of the phenoxyphosphazene units may likewise be present but in smaller amounts. Suitable cyclic phenoxyphosphazenes are obtainable from Fushimi Pharmaceutical Co., Ltd., under the name Rabitle® FP-100. This is a matt-white/yellowish solid having a melting point of 110° C., a phosphorus content of 13.4% and a nitrogen content of 6.0%. The proportion of rings comprising three phenoxyphosphazene units is at least 80.0 wt %.

The thermoplastic molding materials preferably comprise 1.0 to 6.0 wt %, preferably 2.5 to 5.5 wt %, in particular 3.0 to 5.0 wt %, of at least one aliphatic or aromatic ester of phosphoric acid or polyphosphoric acid as flame retardant.

For this reason especially solid, non-migrating phosphate esters having a melting point between 70° C. and 150° C. are preferred. This has the result that the products are easy to meter and exhibit markedly less migration in the molding material. Particularly preferred examples are the commercially available phosphate esters PX-200® (CAS: 139189-30-3) from Daihachi, or Sol-DP® from ICL-IP. Further phosphate esters with appropriate substitution of the phenyl groups are conceivable when this allows the preferred melting range to be achieved. The general structural formula, depending on the substitution pattern in the ortho position or the para position on the aromatic ring, is as follows:

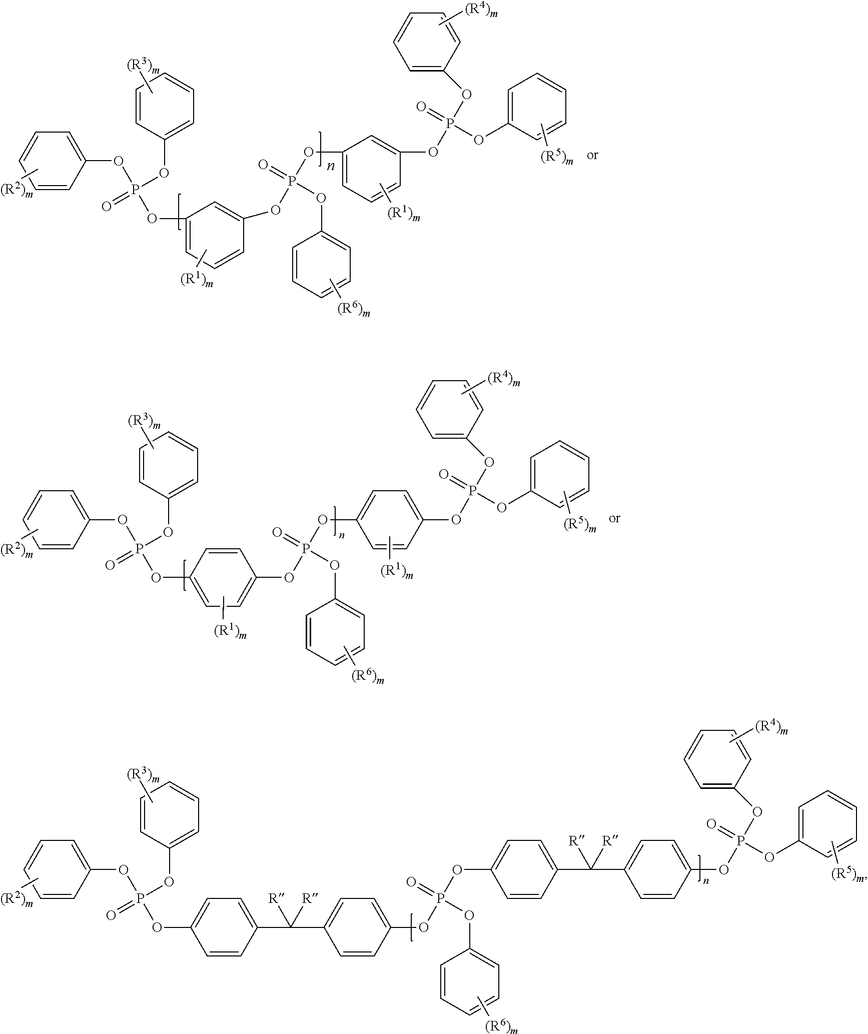

wherein
R¹=H, methyl, ethyl or isopropyl, but preferably H.
n=between 0 and 7, but preferably 0.
R²⁻⁶=H, methyl, ethyl or isopropyl, but preferably methyl. R⁶ is preferably identical to R⁴ and R⁵.
m=may be but need not be identical and is between 1, 2, 3, 4 and 5, but preferably 2.
R″=may be H, methyl, ethyl or cyclopropyl, but preferably methyl and H.

PX-200 is given as a concrete example:

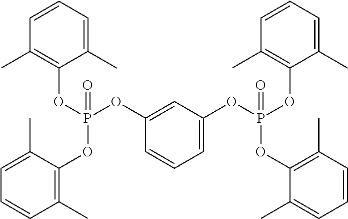 [SMILES: Cc1cccc(C)c1OP(=O)(Oc1cccc(OP(=O)(Oc2c(C)cccc2C)Oc2c(C)cccc2C)c1)Oc1c(C)cccc1C]

It is particularly preferable when at least one aromatic ester of polyphosphoric acid is employed. Such aromatic polyphosphates are obtainable for example from Daihachi Chemical under the name PX-200.

As component D the thermoplastic molding materials according to the invention can comprise 5.0 to 30.0 wt %, preferably 10.0 to 25.0 wt %, in particular 12.0 to 20.0 wt %, for example about 16.0 wt %, of at least one metal phosphinate or phosphinic acid salt described hereinbelow as flame retardant.

The minimum amount of component D is 5.0 wt %, preferably 10.0 wt %, in particular 12.0 wt %.

The maximum amount of component D is 30.0 wt %, preferably 25.0 wt %, particularly preferably 20.0 wt %.

Examples of preferred flame retardants of component D are metal phosphinates derived from hypophosphorous acid. A metal salt of hypophosphorous acid with Mg, Ca, Al or Zn as the metal may be employed for example. Particular preference is given here to aluminum hypophosphite.

Also suitable are phosphinic acid salts of formula (I) or/and diphosphinic acid salts of formula (II) or polymers thereof

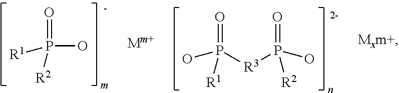

in which
R¹, R² are identical or different and represent hydrogen, C₁-C₆-alkyl, linear or branched, and/or aryl;
R³ represents C₁-C₁₀-alkylene, linear or branched, C₆-C₁₀-arylene, -alkylarylene or -arylalkylene;
M represents Mg, Ca, Al, Sb, Sn, Ge, Ti, Zn, Fe, Zr, Ce, Bi, Sr, Mn, Li, Na, K and/or a protonated nitrogen base;
m=1 to 4; n=1 to 4; x=1 to 4, preferably m=3, x=3.

Preferably, R¹, R² are identical or different and represent hydrogen, methyl, ethyl, n-propyl, isopropyl, n-butyl, tert.-butyl, n-pentyl and/or phenyl.

Preferably, R³ represents methylene, ethylene, n-propylene, isopropylene, n-butylene, tert-butylene, n-pentylene, n-octylene or n-dodecylene, phenylene or naphthylene; methylphenylene, ethylphenylene, tert-butylphenylene, methylnaphthylene, ethylnaphthylene or tert-butylnaphthylene; phenylmethylene, phenylethylene, phenylpropylene or phenylbutylene.

Particularly preferably, R¹, R² are hydrogen, methyl or ethyl, and M is Al, particular preference is given to Al hypophosphite.

Production of the phosphinates is preferably effected by precipitation of the corresponding metal salts from aqueous solutions. However, the phosphinates may also be precipitated in the presence of a suitable inorganic metal oxide or sulfide as support material (white pigments, for example TiO₂, SnO₂, ZnO, ZnS, SiO₂). This accordingly affords surface-modified pigments which can be employed as laser-markable flame retardants for thermoplastic polyesters.

It is preferable when metal salts of substituted phosphinic acids are employed in which compared to hypophosphorous acid one or two hydrogen atoms have been replaced by phenyl, methyl, ethyl, propyl, isobutyl, isooctyl or radicals R′—CH—OH have been replaced by R′-hydrogen, phenyl, tolyl. The metal is preferably Mg, Ca, Al, Zn, Ti, Fe. Aluminum diethylphosphinate (DEPAL) is particularly preferred.

For a description of phosphinic acid salts or diphosphinic acid salts reference may be made to DE-A 199 60 671 and also to DE-A 44 30 932 and DE-A 199 33 901.

Further flame retardants are, for example, halogen-containing flame retardants.

Suitable halogen-containing flame retardants are preferably brominated compounds, such as brominated diphenyl ether, brominated trimethylphenylindane (FR 1808 from DSB) tetrabromobisphenol A and hexabromocyclododecane.

Suitable flame retardants are preferably brominated compounds, such as brominated oligocarbonates (BC 52 or BC 58 from Great Lakes) having the structural formula:

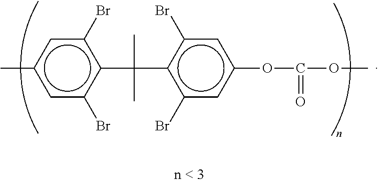

Especially suitable are polypentabromobenzyl acrylates where n>4 (e.g. FR 1025 from ICL-IP having the formula:

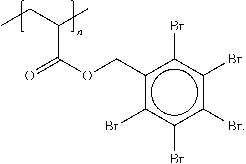

Preferred brominated compounds further include oligomeric reaction products (n>3) of tetrabromobisphenol A with epoxides (e.g. FR 2300 and 2400 from DSB) having the formula:

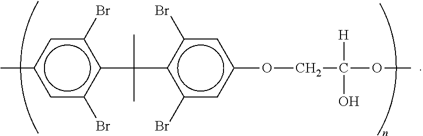

The brominated oligostyrenes preferably employed as flame retardants have an average degree of polymerization (number-average) between 3 and 90, preferably between 5 and 60, measured by vapor pressure osmometry in toluene. Cyclic oligomers are likewise suitable. In a preferred embodiment of the invention the brominated oligomeric styrenes have the formula I shown below in which R represents hydrogen or an aliphatic radical, in particular an alkyl radical, for example CH₂ or C₂H₅, and n represents the number of repeating chain building blocks. R¹ may be H or else bromine or else a fragment of a customary free radical former:

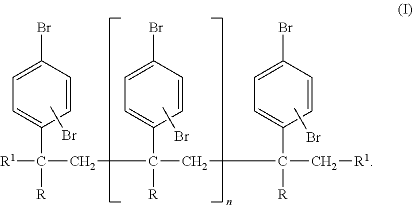

The value n may be 1 to 88, preferably 3 to 58. The brominated oligostyrenes comprise 40.0 to 80.0 wt %, preferably 55.0 to 70.0 wt %, of bromine. Preference is given to a product consisting predominantly of polydibromostyrene. The substances are meltable without decomposing, and soluble in tetrahydrofuran for example. Said substances may be produced either by ring bromination of—optionally aliphatically hydrogenated—styrene oligomers such as are obtained for example by thermal polymerization of styrene (according to DT-OS 25 37 385) or by free-radical oligomerization of suitable brominated styrenes. The production of the flame retardant may also be effected by ionic oligomerization of styrene and subsequent bromination. The amount of brominated oligostyrene necessary for endowing the polyamides with flame-retardant properties depends on the bromine content. The bromine content in the molding materials according to the invention is from 2.0 to 30.0 wt %, preferably from 5.0 to 12.0 wt %.

The brominated polystyrenes according to the invention are typically obtained by the process described in EP-A 047 549:

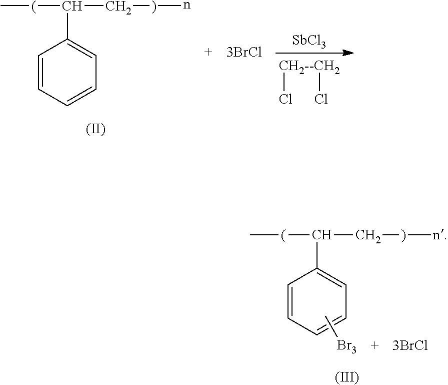

The brominated polystyrenes obtainable by this process and commercially available are predominantly ring-substituted tribrominated products. n′ (see Ill) generally has values of 125 to 1500 which corresponds to a molecular weight of 42500 to 235000, preferably of 130000 to 135000.

The bromine content (based on the content of ring-substituted bromine) is generally at least 50.0 wt %, preferably at least 60.0 wt % and in particular 65.0 wt %.

The commercially available pulverulent products generally have a glass transition temperature of 160° C. to 200° C. and are for example obtainable under the names HP 7010 from Albemarle and Pyrocheck® PB 68 from Ferro Corporation.

Mixtures of the brominated oligostyrenes with brominated polystyrenes may also be employed in the molding materials according to the invention, the mixing ratio being freely choosable.

Also suitable are chlorine-containing flame retardants, Declorane plus from Oxychem being preferable.

Suitable halogen-containing flame retardants are preferably ring-brominated polystyrene, brominated polybenzyl acrylates, brominated bisphenol A epoxide oligomers or brominated bisphenol A polycarbonates.

In one embodiment of the invention no halogen-containing flame retardants are employed in the thermoplastic molding materials according to the invention.

A flame-retardant melamine compound suitable as component D in the context of the present invention is a melamine compound which when added to glass fiber filled polyamide molding materials reduces flammability and influences fire behavior in a fire retarding fashion, thus resulting in improved properties in the UL 94 tests and in the glow wire test.

The melamine compound is for example selected from melamine borate, melamine phosphate, melamine sulfate, melamine pyrophosphate, melam, melem, melon or melamine cyanurate or mixtures thereof.

The melamine cyanurate preferentially suitable according to the invention is a reaction product of preferably equimolar amounts of melamine (formula I) and cyanuric acid/isocyanuric acid (formulae Ia and Ib).

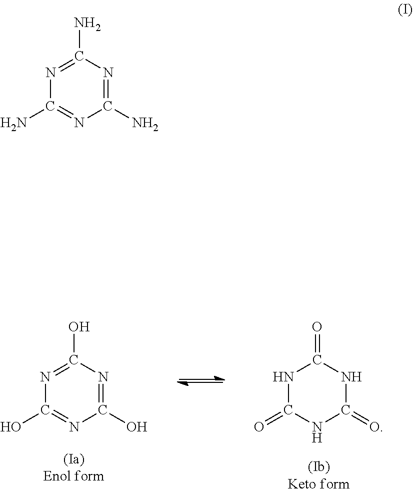 [SMILES: Nc1nc(N)nc(N)n1 ; Oc1nc(O)nc(O)n1 ; O=c1[nH]c(=O)[nH]c(=O)[nH]1]

It is obtained for example by reaction of aqueous solutions of the starting compounds at 90° C. to 100° C. The commercially available product is a white powder having an average grain size d₅₀ of 1.5 to 7 μm and a d₉₉ value of less than 50 μm.

Further suitable compounds (often also described as salts or adducts) are melamine sulfate, melamine, melamine borate, oxalate, phosphate prim., phosphate sec. and pyrophosphate sec., melamine neopentyl glycol borate. According to the invention the molding materials are preferably free from polymeric melamine phosphate (CAS No. 56386-64-2 or 218768-84-4).

This is to be understood as meaning melamine polyphosphate salts of a 1,3,5-triazine compound which have an average degree of condensation number n between 20 and 200 and a 1,3,5-triazine content of 1.1 to 2.0 mol of a 1,3,5-triazine compound selected from the group consisting of melamine, melam, melem, melon, ammeline, ammelide, 2-ureidomelamine, acetoguanamine, benzoguanamine and diaminophenyltriazine per mole of phosphorus atom. Preferably, the n-value of such salts is generally between 40 and 150 and the ratio of a 1,3,5-triazine compound per mole of phosphorus atom is preferably between 1.2 and 1.8. Furthermore, the pH of a 10 wt % aqueous slurry of salts produced according to EP-B1 095 030 will generally be more than 4.5 and preferably at least 5.0. The pH is typically determined by adding 25 g of the salt and 225 g of clean water at 25° C. into a 300 ml beaker, stirring the resultant aqueous slurry for 30 minutes and then measuring the pH. The abovementioned n-value, the number-average degree of condensation, may be determined by means of 31P solid-state NMR. J. R. van Wazer, C. F. Callis, J. Shoolery and R. Jones, J. Am. Chem. Soc., 78, 5715, 1956 discloses that the number of adjacent phosphate groups gives a unique chemical shift which permits clear distinction between orthophosphates, pyrophosphates, and polyphosphates.

Suitable guanidine salts are

| | CAS No. |
|---|---|
| g carbonate | 593-85-1 |
| g cyanurate prim. | 70285-19-7 |
| g phosphate prim. | 5423-22-3 |
| g phosphate sec. | 5423-23-4 |
| g sulfate prim. | 646-34-4 |
| g sulfate sec. | 594-14-9 |
| guanidine pentaerythritol borate | n.a. |
| guanidine neopentyl glycol borate | n.a. |
| and urea phosphate green | 4861-19-2 |
| urea cyanurate | 57517-11-0 |
| ammeline | 645-92-1 |
| ammelide | 645-93-2 |
| melem | 1502-47-2 |
| melon | 32518-77-7 |

In the context of the present invention “compounds” is to be understood as meaning not only for example benzoguanamine itself and the adducts/salts thereof but also the nitrogen-substituted derivatives and the adducts/salts thereof.

Also suitable are ammonium polyphosphate (NH₄PO₃)ₙ where n is about 200 to 1000, preferably 600 to 800, and tris(hydroxyethyl)isocyanurate (THEIC) of formula IV

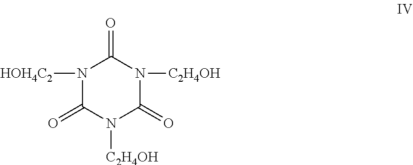

or the reaction products thereof with aromatic carboxylic acids Ar(COOH)ₘ which may optionally be present in a mixture with one another, wherein Ar represents a monocyclic, bicyclic or tricyclic aromatic six-membered ring system and m is 2, 3 or 4.

Examples of suitable carboxylic acids include phthalic acid, isophthalic acid, terephthalic acid, 1,3,5-benzenetricarboxylic acid, 1,2,4-benzenetricarboxylic acid, pyromellitic acid, mellophanic acid, prehnitic acid, 1-naphthoic acid, 2-naphthoic acid, naphthalenedicarboxylic acids, and anthracenecarboxylic acids.

Production is effected by reaction of the tris(hydroxyethyl)isocyanurate with the acids, the alkyl esters thereof or the halides thereof according to the processes in EP-A 584 567.

Such reaction products are a mixture of monomeric and oligomeric esters which may also be crosslinked. The degree of oligomerization is typically 2 to about 100, preferably 2 to 20. Preference is given to using mixtures of THEIC and/or reaction products thereof with phosphorus-containing nitrogen compounds, in particular (NH₄PO₃)ₙ or melamine pyrophosphate or polymeric melamine phosphate. The mixing ratio for example of (NH₄PO₃)ₙ to THEIC is preferably 90.0 to 50.0:10.0 to 50.0, in particular 80.0 to 50.0:50.0 to 20.0, wt % based on the mixture of such compounds.

Also suitable flame retardants are benzoguanidine compounds of formula V

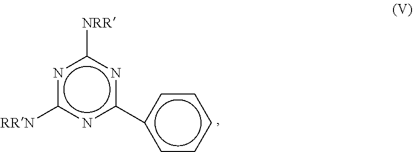

in which R, R′ represents straight-chain or branched alkyl radicals having 1 to 10 carbon atoms, preferably hydrogen, and in particular adducts thereof with phosphoric acid, boric acid and/or pyrophosphoric acid.

Also preferred are allantoin compounds of formula VI,

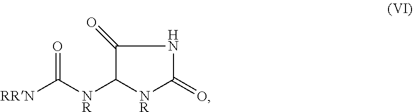

wherein R, R′ are as defined in formula V, and also the salts thereof with phosphoric acid, boric acid and/or pyrophosphoric acid and also glycolurils of formula VII or the salts thereof with the abovementioned acids

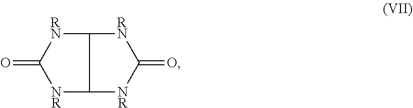

in which R is as defined in formula V.

Suitable products are commercially available or obtainable as per DE-A 196 14 424.

The cyanoguanidine (formula VIII) usable in accordance with the invention is obtainable for example by reacting calcium cyanamide with carbonic acid, the cyanamide produced dimerizing at from pH 9 to pH 10 to afford cyanoguanidine

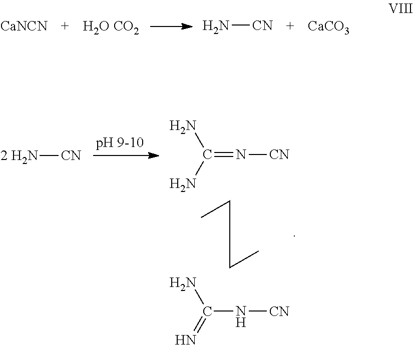

The commercially available product is a white powder having a melting point of 209° C. to 211° C.

It is particularly preferable to employ melamine cyanurate (for example Melapur® MC25 from BASF SE).

It is further possible to employ separate metal oxides such as antimony trioxide, antimony pentoxide, sodium antimonate and similar metal oxides. However it is preferable to eschew the use of such metal oxide since they are already present in component B. For a description of pentabromobenzyl acrylate and antimony trioxide or antimony pentoxide reference may be made to EP-A 0 624 626.

It is also possible to employ phosphorus, for example red phosphorus, as component C. Red phosphorus may for example be employed in the form of a masterbatch.

Also contemplated are dicarboxylic acids of formula

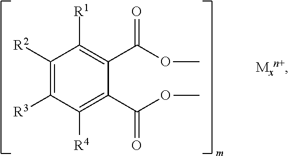

wherein

R¹ to R⁴ independently of one another represent halogen or hydrogen with the proviso that at least one radical R¹ to R⁴ represents halogen,

x=1 to 3, preferably 1, 2

m=1 to 9, preferably 1 to 3, 6, 9, in particular 1 to 3

n=2 to 3

M=alkaline earth metal, Ni, Ce, Fe, In, Ga, Al, Pb, Y, Zn, Hg.

Preferred dicarboxylic acid salts comprise as radicals R¹ to R⁴ independently of one another Cl or bromine or hydrogen, especially preferably all radicals R¹ to R⁴ are Cl or/and Br.

Be, Mg, Ca, Sr, Ba, Al, Zn, Fe are preferred as metals M.

Such dicarboxylic acid salts are commercially available or producible according to the processes described in U.S. Pat. No. 3,354,191.

Also employable as flame-retardant component D are functional polymers. These may be flame-retardant polymers for example. Such polymers are described in U.S. Pat. No. 8,314,202 for example and comprise 1,2-bis[4-(2-hydroxyethoxy)phenyl]ethanone repeating units. A further suitable functional polymer for increasing the amount of carbon residue is poly(2,6-dimethyl-1,4-phenylene-oxide) (PPPO).

The thermoplastic molding compositions of the invention can be produced by processes known per se, by mixing the starting components in conventional mixing apparatus, such as screwbased extruders, Brabender mixers, or Banbury mixers, and then extruding the same. After extrusion, the extrudate can be cooled and pelletized. It is also possible to premix individual components and then to add the remaining starting materials individually and/or likewise in the form of a mixture. The mixing temperatures are generally from 230 to 320° C.

In another preferred mode of operation, components B), C) and D) can also optionally be mixed with a prepolymer, compounded, and pelletized. The pellets obtained are then solid-phase condensed under an inert gas continuously or batchwise at a temperature below the melting point of component A) until the desired viscosity has been reached.

### EXAMPLES

### I. Synthesis of Hyperbranched Polyesters Used as Heat Stabilizers in Polyamide 6

### Example 1

Hyperbranched Polyester

Polyester using pentaerythritol and adipic acid in molar ratio 0.7:1

476.53 g pentaerythritol (3.5 mol), 730.7 g adipic acid (5.0 mol) and 0.6 g titanium(IV) butoxide (0.0018 mol) were added to a 2 L reaction vessel equipped with N₂ inlet, thermometer, stirrer and distillation column. The reaction mixture was slowly heated with the help of an oil bath up to a temperature of 160° C. (oil temperature) under Nitrogen atmosphere. After the complete homogenization of the components, the reaction mixture was kept at 160° C. for 2 hours 45 minutes while water was collected as distillate (80 g). The resulting material (1090 g) was collected and characterized:

Acid number: 201 mg KOH/g according to DIN 53402

Hydroxyl number: 382 mg KOH/g according to DIN 53240 part 2

Gel permeation chromatography in dimethylacetamide (DMAc): Mₙ: 1780 g/mol, M_{w}: 4560 g/mol (calibration against PMMA, detection system: refractive index)

Dispersity: 2.56

### Example 2

Hyperbranched Polyester

Polyester using citric acid monohydrate, trimethylolpropane, L-aspartic acid in molar ratio 2:0.7:0.3

693.50 g citric acid monohydrate (3.3 mol), 154.97 g trimethylolpropane (1.16 mol) and 65.88 g of aspartic acid were added to a 2 L reaction vessel equipped with N₂ inlet, thermometer, stirrer and distillation column. The reaction mixture was slowly heated with the help of an oil bath up to a temperature of 130° C. (oil temperature) under nitrogen atmosphere. After the complete homogenization of the components, the reaction mixture was kept at 130 C for 10 hours minutes, under stirring, while water was collected as distillate (91 g). The resulting material (709 g) was collected and characterized:

Acid number: 466 mg KOH/g according to DIN 53402

Hydroxyl number: 215 mg KOH/g according to DIN 53240 part 2

Gel permeation chromatography in tetrahydrofurane: Mₙ: 501 g/mol, M_{w}: 2540 g/mol

(calibration against PMMA, detection system: refractive index)

Dispersity: 5.06

### Example 3

Hyperbranched Polyester

Polyester using pentaerythritol and adipic acid in molar ratio 0.7:1

476.53 g pentaerythritol (3.5 mol), 730.7 g adipic acid (5.0 mol) and 0.6 g titanium(IV) butoxide (0.0018 mol) were added to a 2 L reaction vessel equipped with N₂ inlet, thermometer, stirrer and distillation column. The reaction mixture was slowly heated with the help of an oil bath up to a temperature of 160° C. (oil temperature) under nitrogen atmosphere. After the complete homogenization of the components, the reaction mixture was kept at 130° C. for four hours, under stirring, while water was collected as distillate (63 g). The resulting material (1000 g) was collected and characterized:

Acid number: 212 mg KOH/g according to DIN 53402

Hydroxyl number: 392 mg KOH/g according to DIN 53240 part 2

Gel permeation chromatography in DMAc: Mₙ: 1710 g/mol, M_{w}: 3750 g/mol

(calibration against PMMA, detection system: refractive index) Dispersity: 2.19

### Example 4

Hyperbranched Polyester

Polyester using pentaerythritol and maleic anhydride in molar ratio 0.7:1

142.96 g pentaerythritol (1.05 mol), 147.09 g maleic anhydride (1.5 mol) were added to a 500 mL reaction vessel equipped with N₂ inlet, thermometer, stirrer and distillation column. The reaction mixture was slowly heated with the help of an oil bath up to a temperature of 140° C. (oil temperature) under nitrogen atmosphere. After the complete homogenization of the components, the reaction mixture was kept at 140° C. for 30 minutes, under stirring. Traces of water as condensate were collected. The resulting material (250 g) was collected and characterized:

Acid number: 176 mg KOH/g according to DIN 53402

Hydroxyl number: 230 mg KOH/g according to DIN 53240 part 2

Gel permeation chromatography in DMAc: Mₙ: 2410 g/mol, M_{w}: 30300 g/mol

(calibration against PMMA, detection system: refractive index)

Dispersity: 12.58

### Example 5

Hyperbranched Polyester

Polyester using cyclohexane-1,2-dicarboxylic acid anhydride and trimethylolpropane in molar ratio 1:1

1176.3 g cyclohexane-1,2-dicarboxylic acid anhydride (7.63 mol), 1023.7 g trimethylolpropane (7.63 mol) were added to a 4 L reaction vessel equipped with N₂ inlet, thermometer, stirrer and distillation column. The reaction mixture was slowly heated with the help of an oil bath up to a temperature of 160° C. (oil temperature) under nitrogen atmosphere. After the complete homogenization of the components, the reaction mixture was kept at 160° C. for 45 minutes, under stirring. Then the temperature was increased to 180° C. and the reaction mixture was kept under stirring for 4 hours while water was condensed out (59 g). The resulting material (2 Kg) was collected and characterized:

Acid number: 83 mg KOH/g according to DIN 53402

Hydroxyl number: 257 mgKOH/g according to DIN 53240 part 2

Gel permeation chromatography in THF: Mₙ: 840 g/mol, M_{w}: 1450 g/mol

(calibration against PMMA, detection system: refractive index)

Dispersity: 1.78

Tg: 17.3

### Example 6

Hyperbranched Polyester

Polyester using cyclohexane-1,2-dicarboxylic acid anhydride and trimethylolpropane in molar ratio 1.2:1

1480 g cyclohexane-1,2-dicarboxylic acid anhydride (9.6 mol), 1073.4 g trimethylolpropane (8 mol) were added to a 4 L reaction vessel equipped with N₂ inlet, thermometer, stirrer and distillation column.

The reaction mixture was slowly heated with the help of an oil bath up to a temperature of 160° C. (oil temperature) under nitrogen atmosphere. After the complete homogenization of the components, the reaction mixture was kept at 160° C. for 45 minutes, under stirring. Then the temperature was increased to 180° C. and the reaction mixture was kept under stirring for 4.75 hours while water was condensed out (73 g). The resulting material (2.3 Kg) was collected and characterized:

Acid number: 93 mg KOH/g according to DIN 53402

Hydroxyl number: 194 mg KOH/g according to DIN 53240 part 2

Gel permeation Chromatography in THF: Mₙ: 1110 g/mol, M_{w}: 2560 g/mol

(calibration against PMMA, detection system: refractive index)

Dispersity: 2.31

Tg: 31.9

### Example 7

Hyperbranched Polyester

Polyester using cyclohexane-1,2-dicarboxylic acid anhydride, neopentyl glycol and trimethylolpropane in molar ratio 1:0.5:0.5

1387.8 g cyclohexane-1,2-dicarboxylic acid anhydride (9 mol), 603.8 g trimethylolpropane (4.5 mol) and 468.7 g neopentyl glycol (4.5 mol) were added to a 4 L reaction vessel equipped with N₂ inlet, thermometer, stirrer and distillation column. The reaction mixture was slowly heated with the help of an oil bath up to a temperature of 140° C. (oil temperature) under nitrogen atmosphere. After the complete homogenization of the components, the temperature was increased to 180° C. and the reaction mixture was kept under stirring for 5 hours while water was condensed out (78 g). The resulting material (2.27 Kg) was collected and characterized: Acid number: 92 mg KOH/g according to DIN 53402

Hydroxyl number: 182 mg KOH/g according to DIN 53240 part 2

Gel permeation Chromatography in THF: Mₙ: 810 g/mol, M_{w}: 1320 g/mol

(calibration against PMMA, detection system: refractive index)

Dispersity: 1.62

Tg: 31.9

### II. Application Examples

For showing the improvement of the long-term heat aging stability of the polyamide molding materials by adding the hyperbranched polyesters, molding compositions were prepared by melt compounding. The components were mixed in a twin-screw extruder (ZSK 26 of Berstorff) at 20 kg/h and 280 to 330° C. employing a flat temperature profile. The obtained extrudates were cooled and granulated.

The test bodies for the tests shown in the following Table 1 were prepared using an injection molding machine (Arburg 420 C) at a polymer temperature of 290 to 330° C. and a tool temperature of 80 to 140° C.

The flame retardancy of the molding composition was determined according to method UL94-V (Underwriters Laboratories Inc. Standard of Safety, “Test for Flammability of Plastic Materials for Parts in Devices and Appliances”, pages 14 to 18, Northbrook 1998).

The glow-wire resistance was determined as the Glow-Wire Flammability Index (GWFI) according to IEC 60695-2-12 as of 2019.

GWFI test was carried out employing 3 test bodies (for example 60×60×1.0 mm plates or round discs) for which with the help of a glow-wire at temperatures between 550 and 960° C., the maximum temperature was determined, which in 3 subsequent tests did not lead to an inflammation after treating with the glow-wire. The test body was pressed for 30 seconds with a power of 1 N against the heated glow-wire. The intrusion depth of the glow wire was restricted to 7 mm. The test was passed when the test body, after removing the glow-wire burned for less than 30 seconds and if a silk paper lying under the test body is not inflamed.

In the test, the following components were employed:

Hereinafter, components A correspond to above component A, components Ex correspond to above component B, components B correspond to above component C, and components C to E correspond to above component D of the molding composition of the invention.

Component A/1:

Polyamide 66 having a viscosity number of 150 mL/g, determined as 0.5 wt % solution in 96 wt % sulfuric acid at 25° C. according to ISO 307 (Ultramid®A27 of BASF SE)

Component A/2:

Polyamide 66 having a viscosity number of 125 mL/g, determined as 0.5 wt % solution in 96 wt % sulfuric acid at 25° C. according to ISO 307 (Ultramid® A24 of BASF SE)

Component A/3:

Polyamide 6 having a viscosity number of 125 mL/g, determined as 0.5 wt % solution in 96 wt % sulfuric acid at 25° C. according to ISO 307 (Ultramid® B24 of BASF SE).

Component A/4:

Polyamide 6 having a viscosity number of 105 mL/g, determined as 0.5 wt % solution in 96 wt % sulfuric acid at 25° C. according to ISO 307 (Ultramid® B22 of BASF SE)

Component A/5:

Polyamide 6 having a viscosity number of 100 mL/g, determined as 0.5 wt % solution in 96 wt % sulfuric acid at 25° C. according to ISO 307 (Genestar® GC61010 of Kuraray Europe GmbH)

Component B:

Commercially available glass fibers for polyamides having a length of 4.5 mm and diameter of 10 μm

Component C/1:

Melamine cyanurate having an average particle size of 2.6 μm (Melapur® MC 25 of BASF SE)

Component C/2:

Halogen-free flame-retardant mixture based on di-alkyl-phosphinates (Exolit® OP1400 of Claiant Plastics & Coatings (Deutschland) GmbH)

Component C/3:

Commercially available zinc stannate (Flamtard® S of William Blythe Ltd.)

Component D/1:

Phenolic antioxidans 3,3′-bis(3,5-di-tert-butyl-4-hydroxyphenyl)-N,N′-hexamethylenedipropionamide (CAS: 23128-74-7 of BASF SE)

Component D/2:

Commercially available heat stabilizer based on Cu(I) iodide (CAS: 7681-65-4)

Component D/3:

Commercially available heat stabilizer based on KI (CAS: 7681-11-0)

The molar ratio of component D/2: component D/3 is 1:4.

Component E/1:

Commercially available processing aid based on glycerol and fatty acids (LOXIOL® P 1206 of Emery Oleochemicals GmbH)

Component E/2:

Commercially available aluminium stearate (CAS: 300-92-5)

Component E/3:

Commercially available ethylene-bis-stearamide (CAS: 110-30-5)

Component Ex1 to Ex7:

Hyperbranched polyesters of Examples 1 to 7 as indicated above

The total weight of all ingredients of components A to Ex in Table 1 sum up to 100 wt %. The compositions and properties of the compositions are shown in Table 1 below.

TABLE 1

| Component | E1 | V1 | E2 | E3 | E4 | E5 | E6 |
|---|---|---|---|---|---|---|---|
| A/1 | 79.1 | 80 | | | | | |
| A/2 | | | 37.95 | | | | |
| A/3 | 10 | 10 | | | | | |
| A/4 | | | 8 | | | | |
| A/5 | | | | 47.9 | 47.9 | 47.9 | 47.9 |
| B | | | 30 | 30 | 30 | 30 | 30 |
| C/1 | 9 | 9 | | | | | |
| C/2 | | | 22.5 | 20 | 20 | 20 | 20 |
| C/3 | | | | 0.15 | 0.15 | 0.15 | 0.15 |
| D/1 | 0.5 | 0.5 | 0.35 | 0.35 | 0.35 | 0.35 | 0.35 |
| D/2 + D/3 | | 0.1 | | | | | |
| E/1 | 0.4 | 0.4 | | | | | |
| E/2 | | | 0.2 | | | | |
| E/3 | | | | 0.6 | 0.6 | 0.6 | 0.6 |
| Ex1 | 1 | | 1 | | | | |
| Ex3 | | | | 1 | | | |
| Ex5 | | | | | 1 | | |
| Ex7 | | | | | | 1 | |
| Ex7 | | | | | | | 1 |
| Test method | E1 | V1 | E2 | E3 | E4 | E5 | E6 |
| Viscosity number [cm³/g] | 147 | 160 | 116 | 82 | 89 | 86 | 87 |
| Modulus of elasticity (ISO 527) [MPa] | 3590 | 3620 | 11790 | 10260 | 10460 | 10470 | 10250 |
| Tensile strength (ISO 527) [MPa] | 75,1 | 76 | 156 | 146 | 136 | 130 | 136 |
| Elongation at break (ISO 527) [%] | 5.1 | 4.4 | 2.6 | 2.2 | 2.1 | 2.0 | 2.2 |
| Impact strength (ISO 179/1eU) [kJ/m²] | 50 | 54.9 | 65 | 50 | 51 | 45 | 53 |
| Notched impact strength | 2.9 | 2.9 | 8.5 | 7.9 | 8.2 | 7.8 | 8.3 |
| (ISO 179/1eA) [kJ/m²] | | | | | | | |
| MVR 275° C./5 Kg (ISO1133) | 195 | 81 | 29 | | | | |
| MVR 325° C./5 Kg (ISO1133) | | | | 94 | 114 | 133 | 116 |
| UL94-V test (0.4 mm) | n.a. | V-0 | V-0 | V-0 | n.a. | V-0 | V-0 |
| GWFI 960° C./0.75 mm | passed | passed | passed | passed | passed | passed | passed |
| Relative tensile strength after heat | 100 | 100 | 100 | 100 | 100 | 100 | 100 |
| aging (180° C. after 0 h) [%] | | | | | | | |
| Relative tensile strength after | 69 | 95 | 83 | 84 | 84 | 86 | 81 |
| heat aging (180° C. after 150 h) [%] | | | | | | | |
| Relative tensile strength after heat | 78 | 65 | 83 | 78 | 78 | 78 | 76 |
| aging (180° C. after 300 h) [%] | | | | | | | |
| Relative tensile strength after heat | 77 | 65 | 79 | 76 | 73 | 76 | 74 |
| aging (180° C. after 500 h) [%] | | | | | | | |
| Relative tensile strength after heat | 89 | 61 | 73 | 69 | 66 | 69 | 66 |
| aging (180° C. after 1000 h) [%] | | | | | | | |
| Relative tensile strength after heat | 81 | 55 | 66 | 58 | 59 | 64 | 58 |
| aging (180° C. after 2000 h) [%] | | | | | | | |

The data of Table 1 show that the molding compositions containing a hyperbranched polyester as additional heat stabilizer show a significantly improved long-term heat aging stability compared to ordinary stabilizers on copper basis. The mechanical properties after heat aging at 180° C. are especially improved.

### III. Application Examples for Molding Compositions Containing Nigrosine

Component A:

Polyamide 6 having a viscosity number VZ of 150 ml/g, determined as 0.5 wt % solution in 96% sulfuric acid by 25° C. according to ISO 307 (Ultramid® B27 of BASF SE)

Component B:

Commercially available glass fibers for polyamides having a length of 4.5 mm and diameter of 10 μm

Component D/2:

Commercially available heat stabilizer based on Cu(I) iodide (CAS: 7681-65-4)

Component D/3:

Commercially available heat stabilizer based on KI (CAS: 7681-11-0)

Component D/4:

Phenolic antioxidans 3,3′-bis(3,5-di-tert-butyl-4-hydroxyphenyl)-N,N′-hexamethylenedipropionamide (CAS: 23128-74-7 of BASF SE)

Component E/3:

Ethylene bis stearamide of Lonza Cologne GmbH (CAS: 110-30-5)

Component E/4:

Nigrosine, solvent black 7 (CAS: 8005-02-5)

Component E/5:

Carbon black, Printex® 60 of Orion Engineered Carbons GmbH

Component Ex1:

Hyperbranched polyester of Example 1.

The compositions and their properties are shown in the following Table 2.

TABLE 2

| Component | V1 | E1 | E2 |
|---|---|---|---|
| A | 69.26 | 68.26 | 68.4 |
| B | 30 | 30 | 30 |
| D/2 | | 0.03 | |
| D/3 | | 0.11 | |
| D/4 | 0.139 | | |
| E/3 | 0.3 | 0.3 | 0.3 |
| E/4 | 0.2 | 0.2 | 0.2 |
| E/5 | 0.1 | 0.1 | 0.1 |
| Ex1 | | 1 | 1 |
| Test methods | V2 | E1 | E2 |
| Modulus of elasticity (ISO 527) [MPa] | 9300 | 9440 | 9395 |
| Tensile strength (ISO 527) [MPa] | 167 | 182 | 177 |
| Elongation at break (ISO 527) [%] | 4.5 | 3.9 | 3.96 |
| MVR 275° C./5 kg [cm³/10'] | 28 | 69 | 73 |
| Relative tensile strength after heat aging (150° C./3000 h) [%] | 78 | 86 | 90 |
| Relative tensile strength after heat aging (180° C./3000 h) [%] | 53 | 79 | 66 |
| Relative elongation at break after heat aging (150° C./3000 h) [%] | 36 | 49 | 51 |
| Relative elongation at break after heat aging (180° C./3000 h) [%] | 21 | 43 | 34 |

The molding composition which is free of metal halides (E2) as well as the molding composition containing metal halides (E1) show superior properties after heat aging over significant time. Furthermore, the mechanical properties at room temperature and the flow behavior are significantly increased.

1. A thermoplastic molding composition, comprising
A) from 10 to 99.9% by weight of a thermoplastic polyamide,
B) from 0.1 to 20% by weight of at least one hyperbranched polyester having an acid number according to DIN 53402 in the range of from 10 to 700 mg KOH/g and a hydroxyl number according to DIN 53240 in the range of from 0 to 550 mg KOH/g,
C) from 0 to 50% by weight of fibrous or particulate fillers, and
D) from 0 to 45% by weight of further additives,
wherein the total of the percentages by weight of components A) to D) is 100% by weight,
wherein the hyperbranched polyester is obtainable by reacting
a) one or more dicarboxylic acid(s) or one or more derivative(s) thereof with one or more at least three functional alcohols, or
b) one or more tricarboxylic acid(s) or higher polycarboxylic acids, or one or more derivative(s) thereof with one or more diol(s),
wherein the carboxylic acids are selected from the group consisting of adipic acid, citric acid, L-aspartic acid, maleic anhydride, and 1,2-cyclohexanedicarboxylic acid anhydride, and the alcohols are selected from the group consisting of pentaerythritol, trimethylolpropane, and neopentyl glycol.

2. The thermoplastic molding composition according to claim 1,
comprising from 1 to 50% by weight of a fibrous or particulate additive C).

3. The thermoplastic molding composition according to claim 1, in which the thermoplastic polyamide A) is selected from the group consisting of aliphatic or semiaromatic polyamides.

4. The thermoplastic molding composition according to claim 1, wherein the at least one hyperbranched polyester has an acid number according to DIN 53402 in the range of from 20 to 550 mg KOH/g and a hydroxyl number according to DIN 53240 of 0 mg KOH/g or in the range of from 100 to 450 mg KOH/g.

5. The thermoplastic molding composition according to claim 1, wherein the at least one hyperbranched polyester has a number average molecular weight Mₙ, determined by gel permeation chromatography in dimethyl acetamide and calibration against PMMA; detection system: refractive index, in the range of from 350 to 20000 g/mol.

6. A method of using at least one hyperbranched polyester as defined in claim 1 as a heat stabilizer in thermoplastic polyamide molding compositions.

7. A method of using the thermoplastic molding composition according to claim 1 for producing fibers, foils, and moldings of any type.

8. A fiber, foil, or molding, made of the thermoplastic molding composition according to claim 1.

9-12. (canceled)

13. The thermoplastic molding composition according to claim 1, in which the thermoplastic polyamide A) is selected from the group consisting of PA 6, PA 66, PA 6/66, PA 66/6, PA 6/6.36, PA 6I/6T, PA 6T/6I, PA 9T and PA 6T/66.
